(19) United States
(12) Patent Application Publication
(10) Pub. No.: US 2025/0311716 A1
(43) Pub. Date: Oct. 9, 2025

(54) METHOD AND SPRAYER SYSTEM FOR CALIBRATING DOSING VALVES FOR FLUID INJECTION

(71) Applicant: Precision Planting LLC, Tremont, IL (US)

(72) Inventors: Chad E Plattner, Tremont, IL (US); Todd Swanson, Morton, IL (US); Luke Stuber, Tremont, IL (US); Brent Wiegand, Mackinaw, IL (US)

(21) Appl. No.: 18/873,391

(22) PCT Filed: Jun. 14, 2023
(86) PCT No.: PCT/IB2023/056150

§ 371 Date: Dec. 10, 2024

Related U.S. Application Data
(60) Provisional application No. 63/367,230, filed on Jun. 29, 2022.

(51) Int. Cl. A01M 7/00; A01C 23/00; A01C 23/04; B05B 12/08

(52) U.S. Cl. CPC A01M 7/0092; A01M 7/0042; B05B 12/082; A01C 23/007; A01C 23/047

(57) ABSTRACT

A method of calibrating dosing valves of a sprayer system of an agricultural implement comprises initiating calibration by filling a calibrating tube with fluid having a fluid from an auxiliary tank of the sprayer system, measuring a volume of the fluid filled into the calibration tube, pumping the fluid in the calibration tube to the dosing valves to calibrate the dosing valves with respect to flow characteristics of the fluid with the dosing valves being capable of a high fluid flow rate to a low fluid flow rate ratio of at least 100:1 for the fluid. The method also includes pumping, during a pump from concentration tank mode, the fluid in the concentration tank to the dosing valves and then to a mixing apparatus with the fluid to be mixed with a carrier fluid from a primary tank of the sprayer system.

### CROSS REFERENCE TO RELATED APPLICATIONS

This application claims priority to U.S. Application No. 63/367,230, filed 29 Jun. 2022, which is incorporated herein by reference in its entirety.

### BACKGROUND

When applying chemicals to a field, such as fertilizer, herbicide, insecticide, or pesticide, there can be some chemicals that are to be applied to the entire field, such as fertilizer. There are some chemicals, such as an herbicide, insecticide, or pesticide, that needs to be applied but not to the entire field. Selective application minimizes waste and saves money. It would be beneficial to have a spraying system that could apply a chemical to the field and selectively apply a second chemical to selected spots in the field.

### BRIEF DESCRIPTION OF THE DRAWINGS

FIG. 1 is an illustration of an agricultural crop sprayer;

FIG. 2 illustrates a method for calibrating dosing valves for controlling fluid flow of a concentrate of a sprayer system in accordance with one embodiment;

FIG. 3 illustrates a fluid application system 300 having a calibration for dosing valves in accordance with one embodiment;

FIG. 3A illustrates a modified fluid application system 300 having a calibration for dosing valves in accordance with one embodiment;

FIG. 4 illustrates a fluid application system 400 (e.g., multiple concentrate direct injection fluid application system) having a calibration for dosing valves for applying fluid with a primary boom in accordance with one embodiment;

FIG. 5 illustrates a fluid application system 500 (e.g., multiple concentrate direct injection fluid application system) having a calibration for dosing valves for applying fluid with a primary boom and a targeted secondary boom in accordance with one embodiment;

FIG. 6 illustrates a fluid application system 600 having a calibration for dosing valves in accordance with one embodiment;

FIG. 6A illustrates a modified fluid application system 600 having a calibration for dosing valves in accordance with one embodiment;

FIG. 7 shows an example of a block diagram of an implement 140 (e.g., sprayer, spreader, irrigation implement, etc.) in accordance with one embodiment;

FIG. 8 shows an example of a block diagram of a system 100 that includes a machine 102 (e.g., agricultural vehicle, tractor, combine harvester, etc.) and an implement 1240 (e.g., planter, cultivator, plough, sprayer, spreader, irrigation implement, etc.) in accordance with one embodiment; and

FIG. 9 illustrates a portion of a fluid application system having a plurality of dosing valves in accordance with one embodiment.

### BRIEF SUMMARY

In an aspect of the disclosure there is provided a method of calibrating dosing valves of a sprayer system of an agricultural implement. The method includes initiating calibration tube fill mode of the sprayer system to initiate calibration by filling a calibration tube with fluid having a chemical from an auxiliary tank of the sprayer system; measuring, during a measure calibration tube volume mode, a volume of the fluid filled into the calibration tube; pumping, during a pump from calibration tube mode, the fluid in the calibration tube to the dosing valves to calibrate the dosing valves with respect to flow characteristics of the fluid with the dosing valves being capable of a high fluid flow rate to a low fluid flow rate ratio of at least 100:1 for the fluid; and pumping, during a pump from concentration tank mode, the fluid in the concentration tank to the dosing valves and then to a mixing apparatus with the fluid to be mixed with a carrier fluid from a primary tank of the sprayer system.

In one example of this method, the dosing valves are calibrated with respect to flow characteristics of the fluid between a high fluid flow rate to a low fluid flow rate ratio of at least 1,000:1.

In one example of this method, the dosing valves are calibrated with respect to flow characteristics of the fluid between a high fluid flow rate to a low fluid flow rate ratio of at least 10,000:1.

In one example of this method, the high fluid flow rate is approximately 4 gallons per minute (GPM) and the low fluid flow rate is approximately 0.0004 GPM.

In one example of this method, the dosing valves are pulse width modulation (PWM) dosing valves.

In one example, this method further comprises pumping, during a pump from concentration tank with recirculation mode, the fluid in the concentration tank to the dosing valves with a valve to the calibration tube being open to allow a recirculation flow path from the concentration tank to the pump to the calibration tube and then returning to the concentration tank.

In one example, this method further comprises rinsing, during a sprayer system rinse mode, the fluid having the chemical out of fluid lines of the sprayer system.

In one example, this method further comprises applying, with a spray boom, the mixed fluid to an agricultural field.

In one example of this method, the dosing valves are integrated with a dosing valve set manifold.

A further aspect of the disclosure provides a sprayer system that comprises at least one auxiliary tank; at least one calibration tube; at least one dosing valve set manifold; and a controller in communication with the at least one dosing valve set manifold. The controller is configured during calibration tube fill mode, to perform operations to fill a calibrating tube with fluid having a chemical from an auxiliary tank of the at least one auxiliary tank, and during a pump from calibration tube mode, to pump the fluid in the calibration tube to the dosing valve set manifold to calibrate dosing valves of the dosing valve set manifold with respect to flow characteristics of the fluid with the dosing valve set manifold being capable of a high fluid flow rate to a low fluid flow rate ratio of at least 100:1 for the fluid.

In one example, this sprayer system further comprises a primary tank; a primary spray boom; and a mixing apparatus to mix fluid from the at least one auxiliary tank and carrier fluid from the primary tank.

In one example of the sprayer system, the controller is configured to perform an operation during a pump from concentration tank mode, to pump the fluid in the at least one auxiliary tank to the dosing valve set manifold and then to the mixing apparatus with the fluid to be mixed with the carrier fluid from the primary tank of the spray system.

In one example of the sprayer system, the dosing valves are calibrated with respect to flow characteristics of the fluid between a high fluid flow rate to a low fluid flow rate ratio of at least 1,000:1.

In one example of the sprayer system, the dosing valves are calibrated with respect to

flow characteristics of the fluid between a high fluid flow rate to a low fluid flow rate ratio of at least 10,000:1.

In one example of the sprayer system, the high fluid flow rate is approximately 4 gallons per minute (GPM) and the low fluid flow rate is approximately 0.0004 GPM.

In one example of the sprayer system, the dosing valves are pulse width modulation (PWM) dosing valves.

In one example, the sprayer system further comprises a pump in fluid communication with the mixing apparatus, the pump is activated in operation to pump if a flow rate of the fluid flowing through the mixing apparatus is below a threshold flow rate in order to prevent laminar flow through the mixing apparatus.

In one example, the sprayer system further comprises a secondary boom having a plurality of nozzles to apply a mixed fluid receiving from the mixing apparatus selectively to selective regions in an agricultural field.

In one example of the sprayer system, the at least one auxiliary tank comprises a first auxiliary tank and a second auxiliary tank, wherein the at least one calibration tube comprises a first calibration tube and a second calibration tube, wherein the at least one dosing valve set manifold comprises a first dosing valve set manifold and a second dosing valve set manifold.

In one example of the sprayer system, each dosing valve set manifold includes a first dosing valve having a first flow rate range and a second dosing valve having a second flow rate range.

In one example of the sprayer system, each dosing valve set manifold includes a first dosing valve having a first flow rate range, a second dosing valve having a second flow rate range, a third dosing valve having a third flow rate range, and a fourth dosing valve having a fourth flow rate range.

### DETAILED DESCRIPTION

All references cited herein are incorporated herein in their entireties. If there is a conflict between a definition herein and in an incorporated reference, the definition herein shall control.

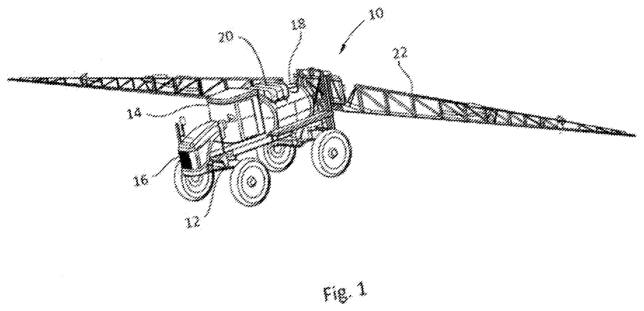

Referring to the drawings, wherein like reference numerals designate identical or corresponding parts throughout the several views, FIG. 1 illustrates an agricultural implement, such as a sprayer 10. While the system can be used on a sprayer, the system can be used on any agricultural implement that is used to apply fluid to soil, such as a side-dress bar, a planter, a seeder, an irrigator, a tillage implement, a tractor, a cart, or a robot. An example of a sprayer is described in U.S. Provisional Application No. 63/153,621, filed on 25 Feb. 2021, and International Application No. PCT/IB2022/051220, filed on 11 Feb. 2022.

FIG. 1 shows an agricultural crop sprayer 10 used to deliver chemicals to agricultural crops in a field. Agricultural sprayer 10 comprises a chassis 12 and a cab 14 mounted on the chassis 12. Cab 14 may house an operator and a number of controls for the agricultural sprayer 10. An engine 16 may be mounted on a forward portion of chassis 12 in front of cab 14 or may be mounted on a rearward portion of the chassis 12 behind the cab 14. The engine 16 may comprise, for example, a diesel engine or a gasoline powered internal combustion engine. The engine 16 provides energy to propel the agricultural sprayer 10 and also can be used to provide energy used to spray fluids from the sprayer 10.

Although a self-propelled application machine is shown and described hereinafter, it should be understood that the embodied invention is applicable to other agricultural sprayers including pull-type or towed sprayers and mounted sprayers, e.g. mounted on a 3-point linkage of an agricultural tractor.

The sprayer 10 further comprises a main liquid storage tank 18 used to store a spray liquid to be sprayed on the field. The spray liquid can include chemicals, such as but not limited to, herbicides, pesticides, and/or fertilizers. Main liquid storage tank 18 is to be mounted on chassis 12, either in front of or behind cab 14. The stored chemicals may be dispersed by the sprayer 10 one at a time or different chemicals may be mixed and dispersed together in a variety of mixtures. The sprayer 10 further comprises a rinse water tank 20 used to store clean water, which can be used for storing a volume of clean water for use to rinse the plumbing and main tank 18 after a spraying operation.

At least one boom arm 22 on the sprayer 10 is used to distribute the fluid from the main liquid tank 18 over a wide swath as the sprayer 10 is driven through the field. The boom arm 22 is provided as part of a spray applicator system, which further comprises an array of spray nozzles arranged along the length of the boom arm 22 and suitable sprayer plumping used to connect the main liquid storage tank 18 with the spray nozzles. The sprayer plumping will be understood to comprise any suitable tubing or piping arranged for fluid communication on the sprayer 10.

Existing spraying systems can broadly apply a chemical from a first boom to the field and selectively apply a second chemical from a second boom to selected spots in the field. However, the existing spray systems for selectively applying a second chemical (e.g., weed killer being applied based on cameras detecting weeds) to selected spots can only vary the flow rate by 40× between maximum and minimum flow rates. However, for certain spray applications, the fluid flow may be varied significantly more than 40× between high fluid flow for certain spots and extremely low fluid flow for other spots in the field. The existing systems use a positive displacement pump that is not able to provide both high fluid flow and extremely low fluid flow.

In one embodiment, a dosing valve set manifold (e.g., pulse width modulation (PWM) dosing valve set manifold) is utilized in sprayer system to provide flow control of a chemical from an auxiliary concentrate tank for any fluid flow between high fluid flow (e.g., 4 gallons per minute (GPM)) and extremely low fluid flow (e.g., 0.0004 GPM) for a dosing rate ratio of 10,000x (10,000:1). In one example, the auxiliary tank provides 2 ounces per acre for one or two nozzles applying 30″ of coverage at 5 MPH for a low fluid flow and 4 GPM at 96 ounces per acre applying a 132 feet of coverage at 20 MPH.

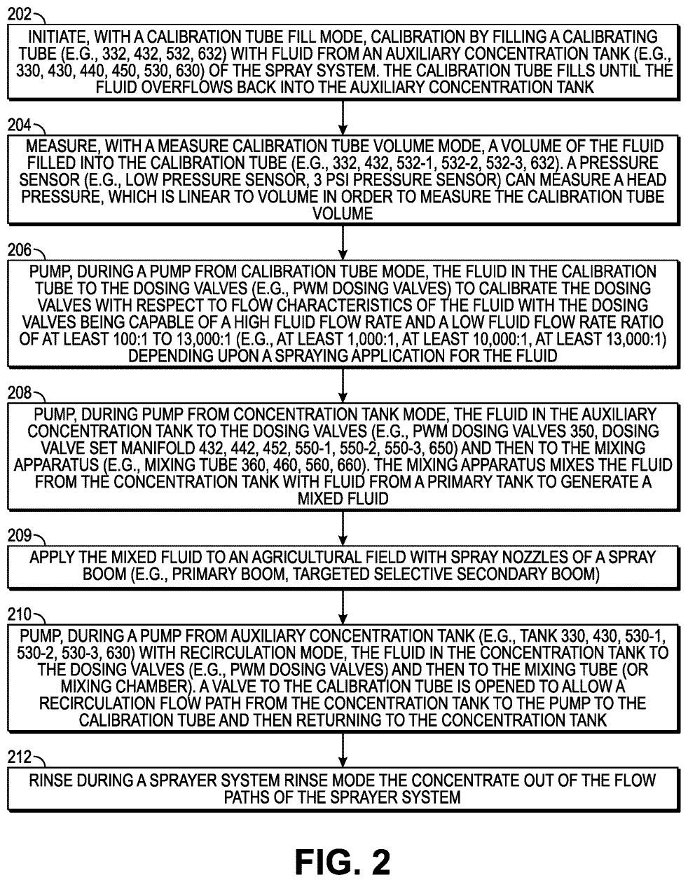

FIG. 2 illustrates a method for calibrating dosing valves for controlling fluid flow of a concentrate of a sprayer system in accordance with one embodiment. The sprayer system can include one or more spray booms, a primary fluid tank, one or more concentration tanks, and different spray system architectures as disclosed herein. At operation 202, the method includes a calibration tube mode to initiate calibration by filling a calibrating tube (e.g., 332, 432, 532, 632) with fluid from an auxiliary concentration tank (e.g., 330, 430, 440, 450, 530, 630) of the spray system. The calibration tube fills until the fluid overflows back into the auxiliary concentration tank.

At operation 204, the method includes a measure calibration tube volume mode to measure a volume of the fluid filled into the calibration tube (e.g., 332, 432, 532-1, 532-2, 532-3, 632). A pressure sensor (e.g., low pressure sensor, 3 psi pressure sensor) can measure a head pressure, which is linear to volume in order to measure the calibration tube volume. The head pressure represents a pressure needed to transfer the fluid from the auxiliary concentration tank into the calibration tube and the pressure sensor will have a static pressure level when the calibration tube is filled completely. Knowing the vertical difference between the overflow level of the calibration tube and the pressure sensor, the density of the concentrate can be calculated from the measured static head pressure in the state where the calibration tube is at the highest level where excess fluid has overflowed back to the auxiliary concentration tank.

In one embodiment, the inside wall of the calibration tube can have hydrophobic properties or can have a hydrophobic coating such that fluid dosed out of the tube doesn't slowly release from the wall requiring additional wait time for the fluid level to equilibrate.

In other embodiments, the calibration tube may have two or more sections of different diameters where the smaller diameters are positioned higher than the larger diameters relative to the ground. When dosing from the calibration tube at low rates, increased accuracy of the volume dosed can be obtained because the smaller diameter produces more change in the head pressure of the product as measured by the low pressure sensor 339. The larger diameter tube section on the bottom of the tube assembly allows for calibrating with larger volumes of product.

At operation 206, the method includes a pump from calibration tube mode to pump the fluid in the calibration tube to the dosing valves (e.g., PWM dosing valves) to calibrate the dosing valves with respect to flow characteristics of the fluid with the dosing valves being capable of a high fluid flow rate and a low fluid flow rate ratio of at least 100:1 to 10,000 to 1 (e.g., at least 100:1, at least 1,000:1, at least 10,000:1, etc.) depending upon a spraying application for the fluid. In one example, a number of dosing cycles for a dosing valve, a pressure, a volume of a calibration tube, and volume drop (as calculated from static head pressure change, tube diameter, and previously calculated concentrate density) during the dosing cycles are known and used to determine a volume of fluid chemical pumped per dosing cycle for the calibration of the dosing valves.

At operation 208, the method includes a pump from concentration tank mode (standard run mode) to pump the fluid in the auxiliary concentration tank to the dosing valves (e.g., PWM dosing valves 350, dosing valve set manifold 432, 442, 452, 550-1, 550-2, 550-3, 650) and then to the mixing apparatus (e.g., mixing tube 360, 460, 560, 660). The mixing apparatus mixes the fluid from the concentration tank with fluid from a primary tank to generate a mixed fluid. At operation 209, the mixed fluid is applied to an agricultural field with spray nozzles of a spray boom (e.g., primary boom, targeted selective secondary boom). The mixed fluid can be selectively applied to the field based on images obtains from the field. For example, images from a vision system of the implement can be captured, analyzed in real time, and this analysis causes the mixed fluid to be selectively applied to selective regions of the field that have weeds or another targeted biomass.

The dosing valves (e.g., pulse width modulation (PWM) dosing valves) are utilized in a sprayer system to provide flow control of a chemical from a concentrate tank for any fluid flow between high fluid flow (e.g., approximately 4 gallons per minute (GPM) with approximately being within +/−5% of a value) and extremely low fluid flow (e.g., approximately 0.0003 to 0.0005 GPM with approximately being within +/−5% of a value) for a high fluid flow rate to low fluid flow rate ratio of at least 100:1 (e.g., at least 100:1, at least 1,000:1, at least 10,000:1, at least 13,000:1) depending upon a spraying application.

At operation 210, the method includes a pump from auxiliary concentration tank (e.g., tank 330, 430, 530-1, 530-2, 530-3, 630) with recirculation mode to pump the fluid in the concentration tank to the dosing valves (e.g., PWM dosing valves) and then to the mixing tube (or mixing chamber). A valve to the calibration tube is opened to allow a recirculation flow path from the concentration tank to the pump to the calibration tube and then returning to the concentration tank. At operation 212, the method includes a sprayer system rinse mode to rinse the concentrate out of the flow paths of the sprayer system. The rinse can include water with a cleaner and may be repeated several times for removing the concentrate from the flow lines of the sprayer system.

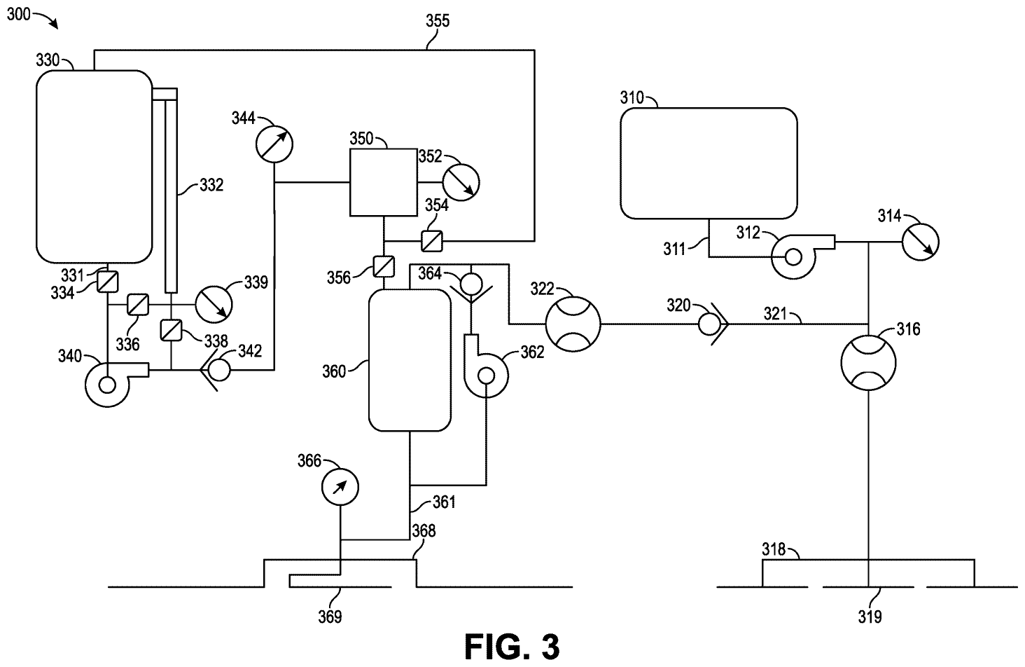

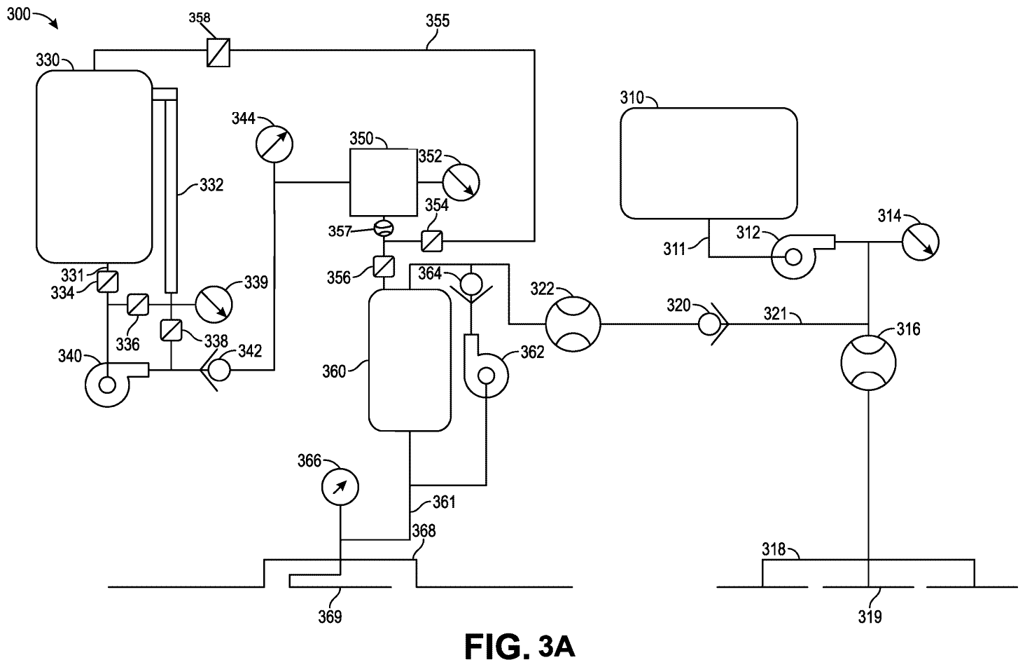

FIG. 3 illustrates a fluid application system 300 having a calibration for dosing valves in accordance with one embodiment. A fluid is a liquid, gas, or other material that continuously deforms under an applied stress or external force. The application system 300 has the primary fluid tank 310. This can contain a carrier fluid or liquid, such as water, and optionally, it can contain a chemical (such as a fertilizer, a pesticide, a herbicide, an insecticide, etc.) that is applied to an entire field. The application system 300 contains at least one auxiliary tank 330. As illustrated in FIG. 3, there is one auxiliary tank. There can be any number of auxiliary tanks depending on the number of additional chemicals to be applied to a field.

Primary tank 310 is connected to a fluid line 311, which connects to pump 312, pressure sensor 314, flow meter 316, primary boom 318, and nozzles 319 that are spread across a width of the primary boom to apply fluid to rows of plants in field. A fluid line 321 connects to flow check device 320, flow meter 322, and mixing apparatus 360 (e.g., mixing tube 360) with a fluid from fluid line 321 to be mixed with a chemical from auxiliary tank 330. The pressure is controlled proportional to a desired flow rate for the fluid lines or the pressure is controlled with the nozzles 319 (e.g., PWM nozzles 319).

Auxiliary tank 330 is connected to a fluid line 331, which connects to valve 334, pump 340, flow check device 342 in case pump 340 loses pressure before pump 312 is shut down, pressure sensor 344, dosing valves 350 (or manifold 350 having dosing valves), pressure sensor 352, valve 356, and mixing apparatus 360. A valve 354 opens or closes a fluid line 355 for a return flow path to the tank 330 in order to avoid applying or wasting the chemical that is pumped during the calibration. A calibration tube 332 is connected to valves 336, 338, and low pressure sensor 339.

A fluid line 361 is connected to an outlet of mixing apparatus 360 and connects to pressure sensor 366, secondary boom 368, and nozzles 369 spread across a width of the secondary boom, which can be used for a targeted selective spray in selective spots based on an analysis of images of plants and weeds in a field that are captured by a vision system. A fluid line 321 connects to flow check device 320, flow meter 322, and mixing apparatus 360 to mix a carrier from tank 310 to a chemical from concentrate tank 330. The pressure is controlled proportional to a desired flow rate for one or more fluid lines or the pressure is controlled with the nozzles 319 (e.g., PWM nozzles 319). The pressure in line 361 is controlled with the nozzles 369 (e.g., PWM nozzles 369).

A fluid line connects to pump 362, flow check device 364, and mixing apparatus 360. The pump 362 is activated in operation if a threshold flow rate (e.g., below 5 to 15 GPM) of the fluid flow through the mixing apparatus is too low causing the flow to switch from turbulent flow (good mixing) to laminar flow (little or no mixing).

The operations of method 201 are performed to calibrate the dosing valves 350 (e.g., at least two dosing valves) with respect to flow characteristics of a fluid of the tank 330 for a high fluid flow rate to low fluid flow rate ratio of at least 100:1 (e.g., at least 100:1, at least 1,000:1, at least 10,000:1, at least 13,000:1) depending upon a spraying application. For example, given a number of dosing cycles for a dosing valve, a pressure, a volume of a calibration tube, and volume drop of fluid (chemical) during the dosing cycles being known, this calibration information is used to determine a volume of a fluid chemical pumped per dosing cycle for the calibration of the dosing valves.

The mixture in mixing apparatus 360 can be selectively applied to the field. Examples include, but are not limited to, applying a specific chemical to a specific location in the field.

Any pump and line individually can be replaced with just a line if the tank supplying fluid to the pump is pressurized to provide the motive force.

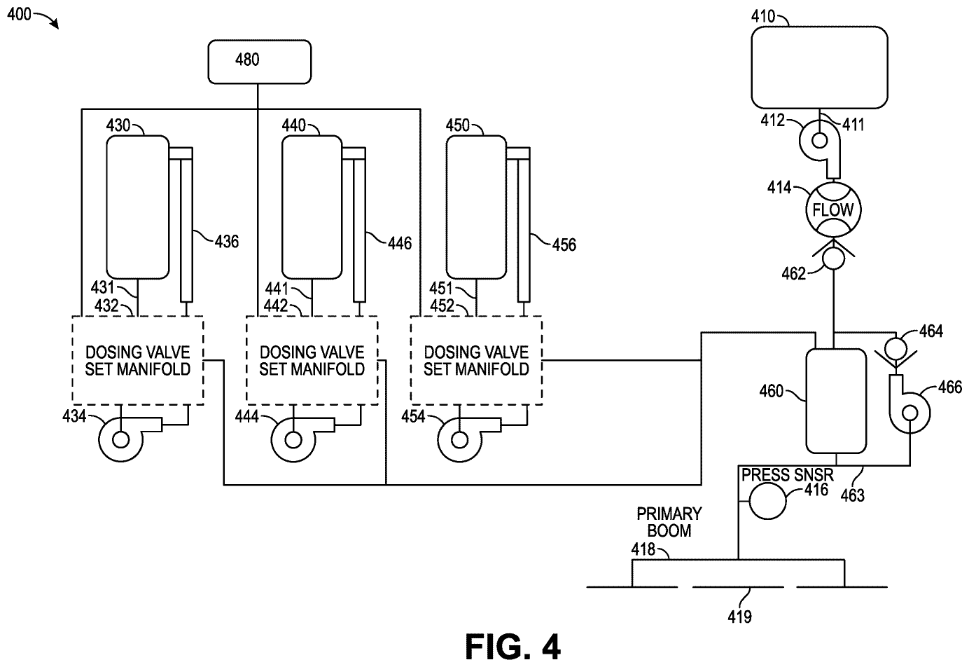

FIG. 4 illustrates a fluid application system 400 (e.g., multiple concentrate direct injection fluid application system) having a calibration for dosing valves for applying fluid with a primary boom in accordance with one embodiment. The application system 400 has the main fluid tank 410. This can contain a carrier fluid or liquid, such as water, and optionally, it can contain a chemical (such as a fertilizer, a pesticide, a herbicide, an insecticide, etc.) that is applied to an entire field. The application system 400 contains at least one auxiliary tank 410. As illustrated in FIG. 4, there is one auxiliary tank. There can be any number of auxiliary tanks depending on the number of additional chemicals to be applied.

Primary tank 410 is connected to a fluid line 411, which connects to pump 412, flow meter 414, flow check device 462, mixing apparatus 460 (e.g., mixing tube 460), pressure sensor 416, primary boom 418, and nozzles 419 that are spread across a width of the primary boom to apply fluid to rows of plants in a field. A fluid line 463 connects to pump 466, flow check device 464, and mixing apparatus 460. The pump 466 is activated in operation if a threshold flow rate (e.g., below 5 to 15 GPM) of the fluid flow through the mixing apparatus is too low causing the flow to switch from turbulent flow (good mixing) to laminar flow (no mixing). The pressure is controlled proportional to a desired flow rate for one or more fluid lines or the pressure is controlled with the nozzles 419 (e.g., PWM nozzles 419).

Auxiliary tank 430 is connected to a fluid line 431, which connects to dosing valve set manifold 432 and associated pump 434, and mixing apparatus 460. A calibration tube 436 is connected to dosing valve set manifold 432 and tank 430.

Auxiliary tank 440 is connected to a fluid line 441, which connects to dosing valve set manifold 442 and associated pump 444, and mixing apparatus 460. A calibration tube 446 is connected to dosing valve set manifold 442 and tank 430.

Auxiliary tank 450 is connected to a fluid line 451, which connects to dosing valve set manifold 452 and associated pump 454, and mixing apparatus 460. A calibration tube 456 is connected to dosing valve set manifold 452 and tank 450.

The operations of method 201 are performed to calibrate the dosing valves of the dosing valve set manifolds with respect to flow characteristics of a fluid of the tanks 430, 440, and 450 for a high fluid flow rate to low fluid flow rate ratio of at least 100:1 (e.g., at least 100:1, at least 1,000:1, at least 10,000:1, at least 13,000:1) depending upon a spraying application.

During a sprayer system rinse mode, a rinse tank 480 having a cleaner is used to rinse the concentrate out of the flow lines of the sprayer system. The rinse can include water with a cleaner and may be repeated several times for removing the concentrate from the flow lines of the sprayer system.

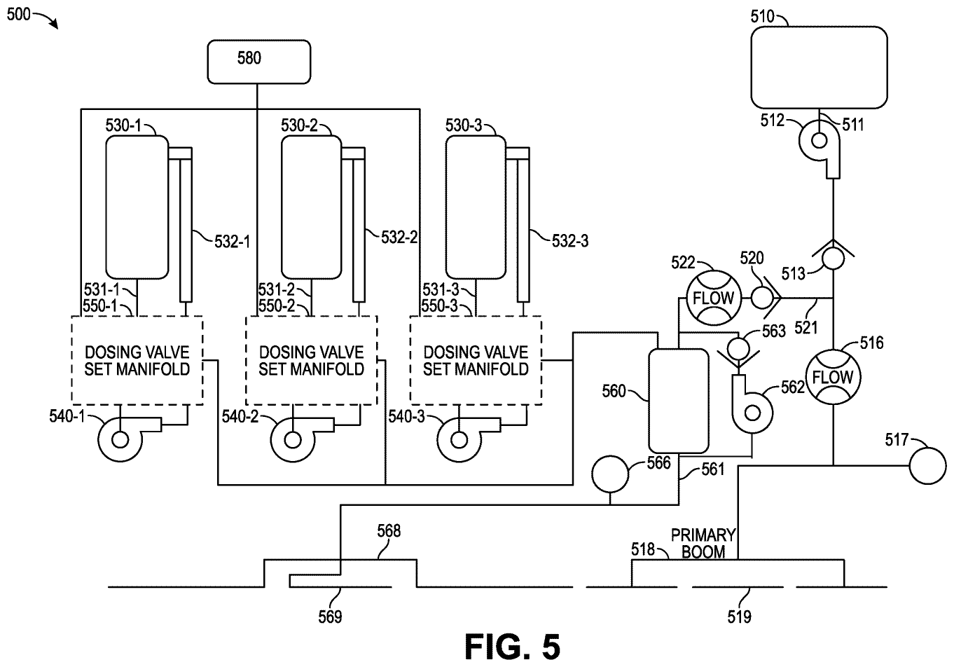

FIG. 5 illustrates a fluid application system 500 (e.g., multiple concentrate direct injection fluid application system) having a calibration for dosing valves for applying fluid with a primary boom and a targeted secondary boom in accordance with one embodiment. The application system 500 has the primary fluid tank 510. This can contain a carrier fluid or liquid, such as water, and optionally, it can contain a chemical (such as a fertilizer, a pesticide, a herbicide, an insecticide, etc.) that is applied to an entire field. The application system 500 contains multiple auxiliary tanks 530-1, 530-2, and 530-3. As illustrated in FIG. 5, there are three auxiliary tanks. There can be any number of auxiliary tanks depending on the number of additional chemicals that may want to be applied.

Primary tank 510 is connected to a fluid line 511, which connects to pump 512, flow check device 513, flow meter 516, pressure sensor 517, primary boom 518, and nozzles 519 that are spread across a width of the primary boom to apply fluid to a biomass such as rows of plants or weeds in a field. A fluid line 521 connects to flow check device 520, flow meter 522, and mixing apparatus 560. The pump 562 is activated in operation if a threshold flow rate (e.g., 5 to 15 GPM) of the fluid flow through the mixing apparatus is too low causing the flow to switch from turbulent flow (good mixing) to laminar flow (little or no mixing). At low velocities for laminar flow, the fluid tends to flow without lateral mixing. For turbulent flow, the fluid undergoes irregular fluctuations and mixing. The pump 562 is connected to flow check device 563. The pressure for one or more fluid lines of the primary boom is controlled proportional to a desired flow rate for line 511 or the pressure is controlled with the nozzles 519 (e.g., PWM nozzles 419).

Auxiliary tank 530-1 is connected to a fluid line 531-1, which connects to dosing valve set manifold 550-1 and associated pump 540-1, and mixing apparatus 560. A calibration tube 532-1 is connected to dosing valve set manifold 550-1 and tank 530-1.

Auxiliary tank 530-2 is connected to a fluid line 531-2, which connects to dosing valve set manifold 550-2 and associated pump 540-2, and mixing apparatus 560. A calibration tube 532-2 is connected to dosing valve set manifold 550-2 and tank 530-2.

Auxiliary tank 530-3 is connected to a fluid line 531-3, which connects to dosing valve set manifold 550-3 and associated pump 540-3, and mixing apparatus 560. A calibration tube 532-3 is connected to dosing valve set manifold 550-3 and tank 530-3.

The operations of method 201 are performed to calibrate the dosing valves of the dosing valve set manifolds with respect to flow characteristics of a fluid of the tanks 530-1, 530-2, and 530-3 for a high fluid flow rate to low fluid flow rate ratio of at least 100:1 (e.g., at least 100:1, at least 1,000:1, at least 10,000:1, at least 13,000:1) depending upon a spraying application.

Prior to cleaning the system, it is desired to get as much of the product back to the auxiliary fluid tank as possible so it can be reclaimed. This is also advantageous because there is less product to rinse, less rinse water required, and the process will take less time. To push product back to the auxiliary tank, compressed air can be used. Purge air can be injected on the pump side of tank valve 634, and preferably as close as possible to the valve 634.

For increased efficiency of reclaiming product, valves 665 and 666 are located close to the point of injection at the mixer 660. This minimizes product in the line that cannot be pushed back to the tank by air.

During a sprayer system rinse mode, a rinse tank 580 having a cleaner is used to rinse the concentrate out of the flow lines of the sprayer system. The rinse can include water with a cleaner and may be repeated several times for removing the concentrate from the flow lines of the sprayer system.

The dosing valve set manifolds are connected to the mixing apparatus 560, which connects to fluid line 561, pressure sensor 566, targeted spray boom 568, and nozzles 569 (e.g., PWM nozzles).

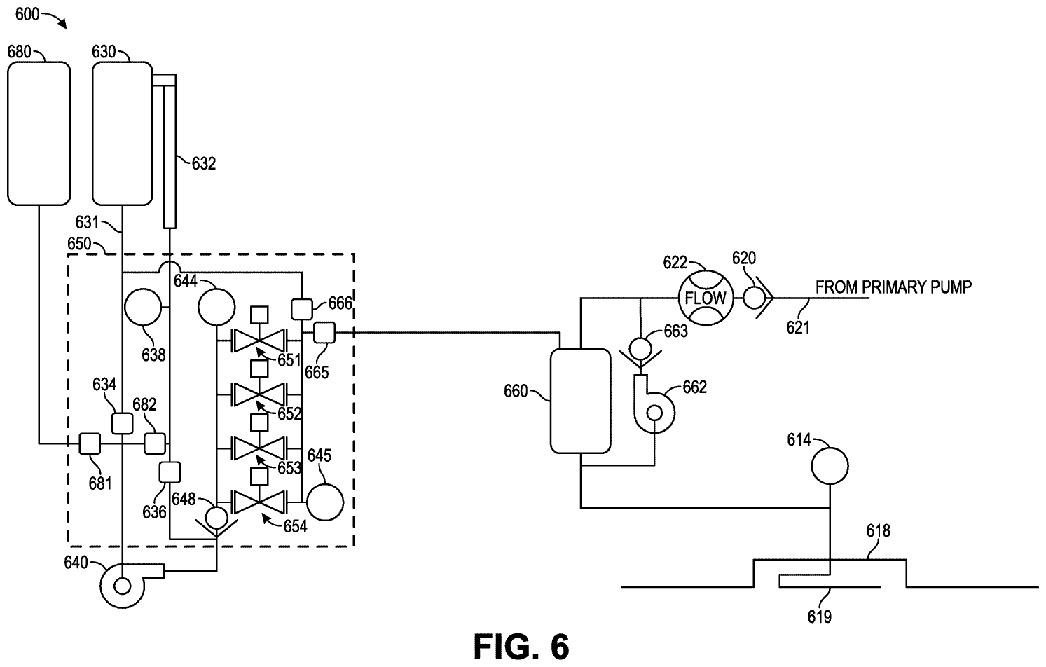

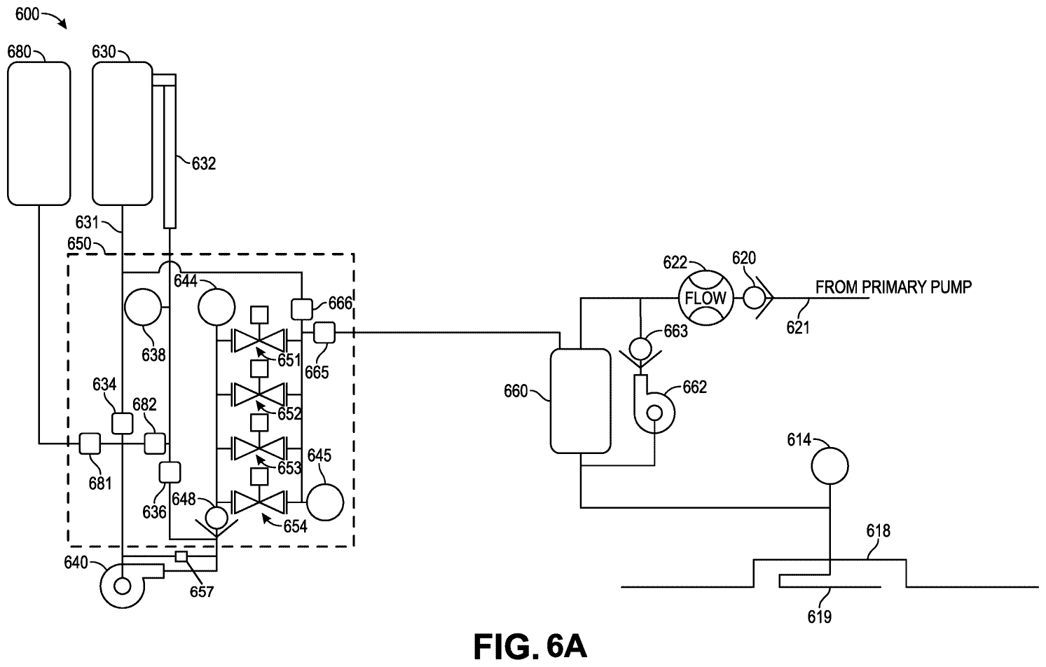

FIG. 6 illustrates a fluid application system 600 having a calibration for dosing valves in accordance with one embodiment. The application system 600 has a primary fluid tank (not shown). This primary fluid tank can contain a carrier fluid or liquid, such as water, and optionally, it can contain a chemical (such as a fertilizer, a pesticide, a herbicide, an insecticide, etc.) that is applied to an entire field. The application system 600 contains at least one auxiliary tank 630. As illustrated in FIG. 6, there is one auxiliary tank. There can be any number of auxiliary tanks depending on the number of additional chemicals to be applied to a field.

The primary tank (not shown) is connected to a flow check device 620, a fluid line 621, a flow meter 622, and a mixing apparatus 660, which connects to pump 662, a flow check device 663, a pressure sensor 614, a primary boom 618, and nozzles 619 that are spread across a width of the primary boom to apply fluid to a biomass such as rows of plants or weeds in field. A fluid from fluid line 621 can be mixed with a chemical from tank 630. The pressure is controlled proportional to a desired flow rate with the nozzles 619 (e.g., PWM nozzles 619).

Auxiliary tank 630 is connected to a fluid line 631, which connects to valve 634, pump 640, flow check device 648 in case pump 640 loses pressure before a primary pump is shut down, pressure sensor 644, and dosing valve set manifold 650 having dosing valves 651-654. A valve 665 connects the manifold 650 to mixing apparatus 660. A calibration tube 632 is connected to valves 682, 636, and low pressure sensor 638. A rinse tank 680 is connected to valves 681, 682, and 634, which can be replaced with a three way valve. The manifold 650 in one example includes valves 681, 634, 682, 636, 666, 665, dosing valves 651-654, flow check device 648, and pressure sensors 644 and 645. The valves 666 and 665 can be replaced with a three way valve.

The pump 640 is controlled to maintain a constant pressure to a common rail to the dosing valves 651-654.

The operations of method 201 are performed to calibrate the dosing valves (e.g., at least two dosing valves) with respect to flow characteristics of a fluid of the tank 630 for a high fluid flow rate to low fluid flow rate ratio of at least 100:1 (e.g., at least 100:1, at least 1,000:1, at least 10,000:1, at least 13,000:1) depending upon a spraying application. In one example, dosing valves have a low flow rate of 0.0004 GPM to a high flow rate of 4.0 GPM. A first dosing valve has a first flow rate range (e.g., 0.0003 to 0.027 GPM for 0.7% of full flow range), a second dosing valve has a second flow rate range (e.g., 0.0238 to 0.4760 GPM for 12% of full flow range), a third dosing valve has a third flow rate range (e.g., 0.037 to 1.75 GPM for 44% of full flow range), and a fourth dosing valve has a fourth flow rate range (e.g., 0.037 to 1.75 GPM for 44% of full flow range).

During a sprayer system rinse mode, a rinse tank 680 having a cleaner is used to rinse the concentrate out of the flow lines of the sprayer system. The rinse can include water with a cleaner and may be repeated several times for removing the concentrate from the flow lines of the sprayer system.

The mixture in mixing apparatus 660 can be selectively applied to the field. Examples include, but are not limited to, applying a specific chemical to a specific location in the field.

PWM valves and three way valves can be controlled with a controller, such as controller 200 described in International Publication No. WO2020/178663, which can be connected to a monitor 1000, such as is described in U.S. Pat. No. 8,078,367.

Examples of flow meters described herein include, but are not limited to, electromagnetic flow meters, such as EM FlowSense™ from Precision Planting LLC. Examples of valves described herein include, but are not limited to, ball valves, such as EMHD control valves from Precision Planting LLC, pulse width modulation valves, or gated valves. A flow check device can be a check valve.

In one embodiment, a pump (e.g., pump 340, 434, 444, 454, 540-1, 540-2, 540-3, 640) for one or more auxiliary tanks (e.g., 330, 430, 440, 450, 530-1, 530-2, 530-3, 630) has a higher pressure (e.g., 100-110 psi) than a pump (e.g., 312, 412, 512, 612) for a primary tank (e.g., 310, 410, 510) in order to have a pressure gradient across the dosing valves (e.g., 350, 432, 442, 452, 550-1, 550-2, 550-3, 651-654).

Maintaining a consistent pressure across the dosing valve during the time that the valve is open can be used to obtain uniform dosing per pulse. To monitor this pressure differential, a pressure sensor 344 is placed on the pump side of dosing valve 350 and another pressure sensor 352 is placed on the outlet side of dosing valve 350. The processing system 1200 records the average pressure differential across dosing valve 350 during the duration that dosing valve 350 is open. The pressure differential averaging doesn't begin until dosing valve 350 has opened. There is a delay from when the valve coil is energized until fluid begins flowing, which can be about 16 ms. The pressure differential averaging doesn't end until dosing valve 350 closes. There is a delay from when the coil is deenergized until fluid stops flowing, which can be about 24 ms. When more than one dosing valve 350 is being commanded, the average pressure differential across the dosing valve 350 (when fluid is flowing) is measured for each dosing valve 350 individually and then all active dosing valves 350 are averaged together. Whether a single dosing valve 350 is active or multiple dosing valves 350 are active, the average pressure differential across dosing valve 350 while the valve is open is the metric that pump input power is controlled to maintain. A PID control loop can used to control the pump power input to maintain a consistent pressure differential. In one embodiment, a typical pressure differential that pump is controlled to is 30 psi.

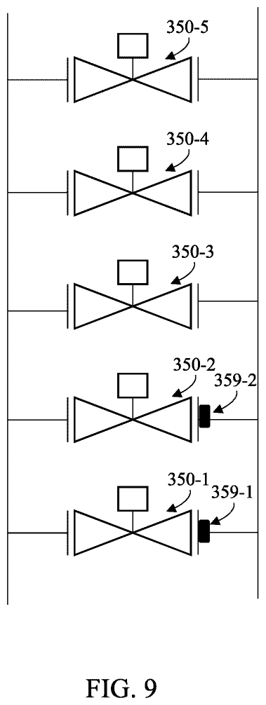

One implementation is multiple (such as 5) dosing valves 350 (350-1, 350-2, 350-3, 350-4, 350-5) illustrated in FIG. 9, which can be used in a system as illustrated with four valves 651, 652, 653, 654 in FIG. 6. The (350-1, 350-2, 350-3, 350-4, 350-5) are calibrated and can operate at the same dosing frequency. In some embodiments, a 5 Hz dosing frequency is typical. A minimum pulse duration is used such that the duration is long enough to produce a consistent dose for each pulse. In some embodiments, a typical minimum pulse duration is 16 ms. A maximum pulse duration can be used such that enough time is given for the valve to close and open again consistently to produce a consistent dose for each pulse. In some embodiments, a typical maximum pulse duration is 180 ms when using a 5 Hz (200 ms period) dosing frequency.

While all (350-1, 350-2, 350-3, 350-4, 350-5) can be identical, the first dosing valve 350-1 has a small orifice 359-1 placed immediately downstream of first dosing valve 350-1 to lower the volume dosed per pulse. This orifice may be 0.6 mm (0.024″) diameter. The second dosing valve 350-2 also has an orifice 359-2 placed immediately downstream of valve 350-2 to lower the volumed dosed per pulse. This orifice can be sized such that at the minimum valve open time that is dosed per pulse is less than the first dosing valve 350-1 at its maximum valve open time. This orifice may be 1.2 mm (0.049″) diameter. The system can be designed so that the flow rates of the first and second dosing valves (350-1, 350-2) overlap for an uninterrupted handoff from the first dosing valve 350-1 to the second dosing valve 350-2 as the desired dosed flow rate increases. The third, fourth, and fifth dosing valves (350-3, 350-4, 350-5) don't have an orifice enabling them to output their full rate per pulse. A similar overlap can exist between the second and third dosing valves (350-2 and 350-3) where the minimum rate of the third dosing valve 350-3 is less than the maximum rate of the second dosing valve 350-2. When the output rate of the third dosing valve 350-3 is at its maximum, the mode of dosing transitions from using a single valve to dosing valve 350-3, dosing valve 350-4, and dosing valve 350-5 dosing together out of phase to each other each by ⅓ of a period, all operating at the same pulse duration.

When a single or multiple positive displacement pumps, such as diaphragm or piston pump types, are operated at low dosing rates, the pumps inherently operate at low speeds which is difficult for stable pressure control as they produce low frequency pressure spikes on the input of the dosing valves that negatively impacts the dosing consistency. A solution to this is a constant flow valve that allows a consistent rate to be flowing regardless of dosing rate. A typical pump bypass flow rate is 0.75 GPM. At high output, it is desired that bypass flow is stopped so all of the flow can go to the dosing valves. To accomplish this, a valve 657 is used inline with constant flow valve to stop the bypass flow when desired. The processing system closes the valve 657 when the pump output exceeds a value, such as 75% of the pump command. The processing system opens the valve 657 when the pump output drops below a value, such as 25% of the pump command. The wide hysteresis prevents this producing an instability into the pump control.

During the calibration process the product being dosed is returned to the product tank (e.g. auxiliary tank 330, 430, 530-1, 530-2, 530-3, 630). When the return path is directly to the product tank, the outlet pressure of the dosing valves 350 is close to atmospheric pressure. During standard operation, the outlet pressure of the dosing valves 350 is higher than atmospheric pressure, for example 275-550 kPa (40 to 80 PSI). To simulate typical operating pressure, a backpressure valve 358 can be used inline on the return to the tank. Calibration accuracy is improved when the backpressure valve simulates typical operating conditions.

A flow meter 357 can be placed inline between the outlet of the dosing valves 350 and the diverter valve(s) 354 & 356. During active dosing, the flow meter 357 can be monitored for flow rate and accumulated volume dosed. For additional accuracy during fluctuations of the commanded flow rate, a short-term rolling accumulated volume can be calculated. A typical time duration for the rolling differential of the accumulated volume dosed and the accumulated volume commanded is 1 to 2 seconds. The time duration could be dynamic based on the amount of time it takes for the carrier to pass through the mixer. If the short-term rolling accumulated volume dosed compared to the accumulated volume commanded exceeds or falls behind, a PID control loop can be used to dose at an increased rate or decreased rate accordingly in an effort to bring the differential to zero.

When a flow meter 357 is placed inline between the outlet of the dosing valves 350 and the diverter valve(s) 354 & 356, the flow meter's output of volume per second can be measured using the volume measured while dosing from the calibration tube. The output of the flow meter 357 can be calibrated at multiple flow rates to account for fluid bypass in the flow meter 357.

When using a flow meter 357 with error less than 1% across the full flow range, the dosing valve 350 can be calibrated by using the feedback from the flow meter 357. The calibration tube 332 is not required in this case.

The direct injection system processing system determines the amount of product to dose based on the measured carrier flow from the flow meter 322. If the sprayer system is controlled by a processing system and that processing system is able to communicate the commanded carrier flow rate to the direct injection processing system, the delay in matching the dosing rate to the carrier rate can be reduced which produces more accurate performance.

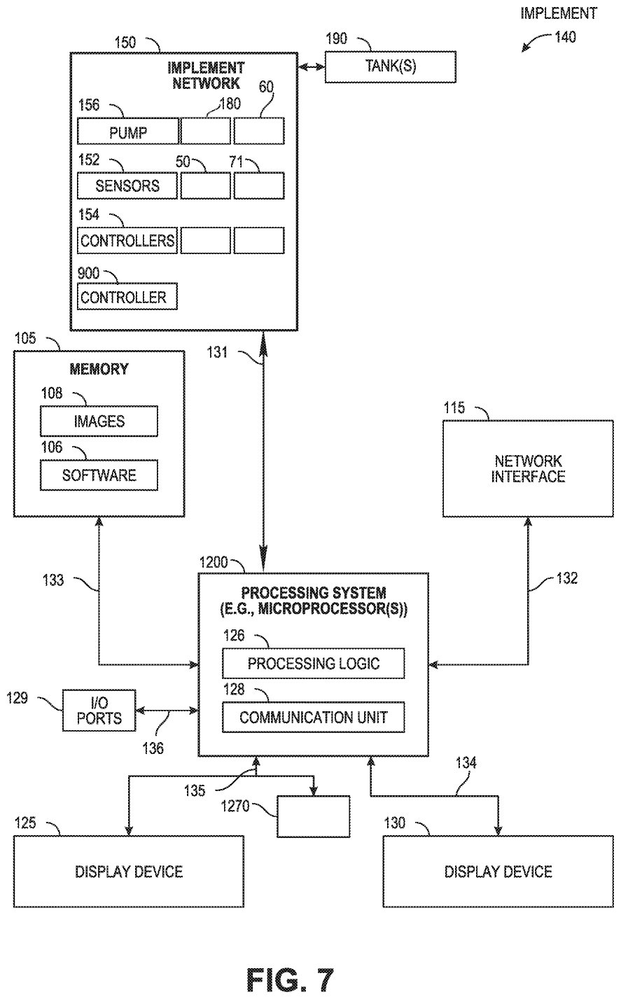

FIG. 7 shows an example of a block diagram of an implement 140 (e.g., sprayer, spreader, irrigation implement, etc.) in accordance with one embodiment. The implement 140 includes a processing system 1200, memory 105, and a network interface 115 for communicating with other systems or devices. The network interface 115 can include at least one of a GPS transceiver, a WLAN transceiver (e.g., WiFi), an infrared transceiver, a Bluetooth transceiver, Ethernet, or other interfaces from communications with other devices and systems. The network interface 115 may be integrated with the implement network 150 or separate from the implement network 150 as illustrated in FIG. 7. The I/O ports 129 (e.g., diagnostic/on board diagnostic (OBD) port) enable communication with another data processing system or device (e.g., display devices, sensors, etc.).

In one example, the implement 140 is a self-propelled implement that performs operations for fluid applications of a field. Data associated with the fluid applications can be displayed on at least one of the display devices 125 and 130.

The processing system 1200 may include one or more microprocessors, processors, a system on a chip (integrated circuit), or one or more microcontrollers. The processing system includes processing logic 126 for executing software instructions of one or more programs and a communication unit 128 (e.g., transmitter, transceiver) for transmitting and receiving communications from the network interface 115 or implement network 150. The communication unit 128 may be integrated with the processing system or separate from the processing system.

Processing logic 126 including one or more processors may process the communications received from the communication unit 128 including agricultural data (e.g., planting data, GPS data, fluid application data, flow rates, etc.). The system 1200 includes memory 105 for storing data, images 108, and programs for execution (software 106) by the processing system. The memory 105 can store, for example, software components such as fluid application software for analysis of fluid applications for performing operations of the present disclosure, or any other software application or module, images (e.g., captured images of crops, images of a spray pattern for rows of crops), alerts, maps, etc. The memory 105 can be any known form of a machine readable non-transitory storage medium, such as semiconductor memory (e.g., flash; SRAM; DRAM; etc.) or non-volatile memory, such as hard disks or solid-state drive. The system can also include an audio input/output subsystem (not shown) which may include a microphone and a speaker for, for example, receiving and sending voice commands or for user authentication or authorization (e.g., biometrics).

The processing system 1200 communicates bi-directionally with memory 105, implement network 150, network interface 115, display device 130, display device 125, and I/O ports 129 via communication links 131-136, respectively.

Display devices 125 and 130 can provide visual user interfaces for a user or operator. The display devices may include display controllers. In one embodiment, the display device 125 is a portable tablet device or computing device with a touchscreen that displays data (e.g., PWM data for PWM valves, nozzle condition data, planting application data, fluid calibration or fluid application data, captured images, localized view map layer, high definition field maps of as-applied fluid or fluid application data, as-planted or as-harvested data or other agricultural variables or parameters, yield maps, alerts, etc.) and data generated by an agricultural data analysis software application and receives input from the user or operator for an exploded view of a region of a field, monitoring and controlling field operations. The operations may include configuration of the machine or implement, reporting of data, control of the machine or implement including sensors and controllers, and storage of the data generated. The display device 125 may be a display (e.g., display provided by an original equipment manufacturer (OEM)) that displays images and data for a localized view map layer, as-applied fluid or fluid application data, as-planted or as-harvested data, yield data, controlling an implement (e.g., planter, tractor, combine, sprayer, etc.), steering the implement, and monitoring the implement (e.g., planter, combine, sprayer, etc.). A cab control module 1270 may include an additional control module for enabling or disabling certain components or devices of the implement.

The implement 140 (e.g., planter, cultivator, plough, sprayer, spreader, irrigation, implement, etc.) includes an implement network 150 having multiple networks. The implement network 150 having multiple networks (e.g., Ethernet network, Power over Ethernet (PoE) network, a controller area network (CAN) serial bus protocol network, an ISOBUS network, etc.) may include a pump 156 for pumping fluid from a primary and one or more auxiliary storage tank(s) 190 to row units of the implement, communication module 180 for receiving communications from controllers and sensors and transmitting these communications. In one example, the implement network 150 includes valve and nozzle assemblies 50, lights 60, and vision guidance system 71 having cameras and processors.

Sensors 152 (e.g., speed sensors, seed sensors for detecting passage of seed, downforce sensors, actuator valves, OEM sensors, flow sensors, etc.), controllers 154 (e.g., drive system, GPS receiver, controller(s) for one or more pumps and valves for fluid applications as described herein), and the processing system 120 control and monitoring operations of the implement.

The OEM sensors may be moisture sensors or flow sensors, speed sensors for the implement, fluid application sensors for a sprayer, or vacuum, lift, lower sensors for an implement. For example, the controllers may include processors in communication with a plurality of sensors. The processors are configured to process data (e.g., fluid application data) and transmit processed data to the processing system 120. The controllers and sensors may be used for monitoring motors and drives on the implement.

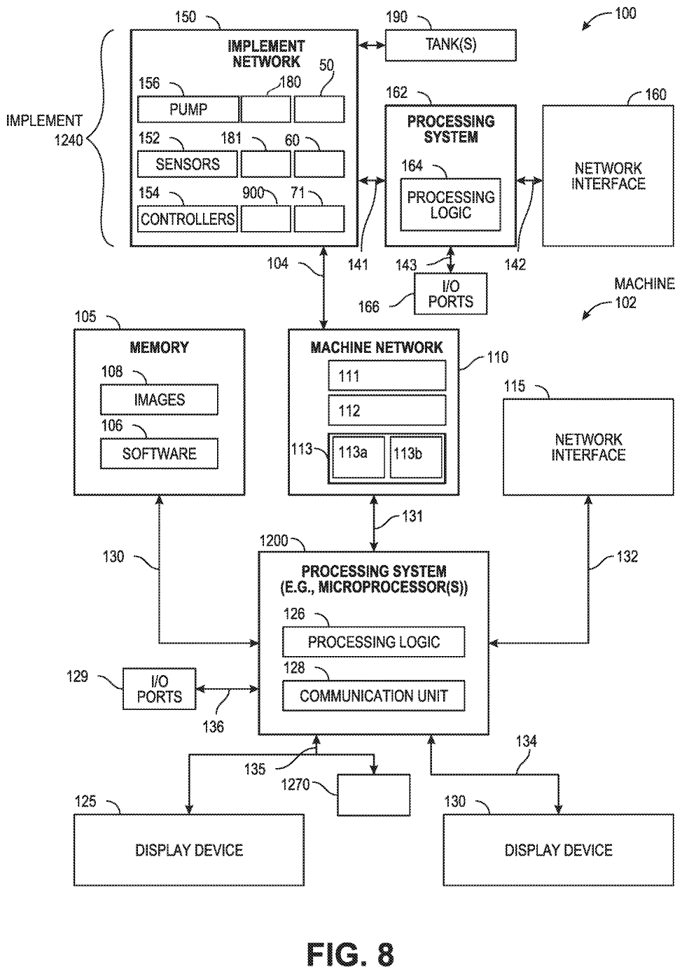

FIG. 8 shows an example of a block diagram of a system 100 that includes a machine 102 (e.g., agricultural vehicle, tractor, combine harvester, etc.) and an implement 1240 (e.g., planter, cultivator, plough, sprayer, spreader, irrigation implement, etc.) in accordance with one embodiment. The machine 102 includes a processing system 1200, memory 105, machine network 110 that includes multiple networks (e.g., an Ethernet network, a network with a switched power line coupled with a communications channel (e.g., Power over Ethernet (PoE) network), a controller area network (CAN) serial bus protocol network, an ISOBUS network, etc.), and a network interface 115 for communicating with other systems or devices including the implement 1240. The machine network 110 includes sensors 112 (e.g., speed sensors), controllers 111 (e.g., GPS receiver, radar unit) for controlling and monitoring operations of the machine or implement. The network interface 115 can include at least one of a GPS transceiver, a WLAN transceiver (e.g., WiFi), an infrared transceiver, a Bluetooth transceiver, Ethernet, or other interfaces from communications with other devices and systems including the implement 1240. The network interface 115 may be integrated with the machine network 110 or separate from the machine network 110 as illustrated in FIG. 8. The I/O ports 129 (e.g., diagnostic/on board diagnostic (OBD) port) enable communication with another data processing system or device (e.g., display devices, sensors, etc.).

In one example, the machine is a self-propelled machine that performs operations of a tractor that is coupled to and tows an implement for planting or fluid applications of a field. Data associated with the planting or fluid applications can be displayed on at least one of the display devices 125 and 130.

The processing system 1200 may include one or more microprocessors, processors, a system on a chip (integrated circuit), or one or more microcontrollers. The processing system includes processing logic 126 for executing software instructions of one or more programs and a communication unit 128 (e.g., transmitter, transceiver) for transmitting and receiving communications from the machine via machine network 110 or network interface 115 or implement via implement network 150 or network interface 160. The communication unit 128 may be integrated with the processing system or separate from the processing system. In one embodiment, the communication unit 128 is in data communication with the machine network 110 and implement network 150 via a diagnostic/OBD port of the I/O ports 129 or via network devices 113a and 113b. A communication module 113 includes network devices 113a and 113b. The communication module 113 may be integrated with the communication unit 128 or a separate component.

Processing logic 126 including one or more processors may process the communications received from the communication unit 128 including agricultural data (e.g., planting data, GPS data, fluid application data, flow rates, etc.). The system 1200 includes memory 105 for storing data and programs for execution (software 106) by the processing system. The memory 105 can store, for example, images 108 of crops, weeds, insects and other field conditions as well as software components such as fluid application software for analysis of planting applications for performing operations of the present disclosure, or any other software application or module, images (e.g., captured images of crops), alerts, maps, etc. The memory 105 can be any known form of a machine readable non-transitory storage medium, such as semiconductor memory (e.g., flash; SRAM; DRAM; etc.) or non-volatile memory, such as hard disks or solid-state drive. The system can also include an audio input/output subsystem (not shown) which may include a microphone and a speaker for, for example, receiving and sending voice commands or for user authentication or authorization (e.g., biometrics).

The processing system 1200 communicates bi-directionally with memory 105, machine network 110, network interface 115, display device 130, display device 125, and I/O ports 129 via communication links 130-136, respectively.

Display devices 125 and 130 can provide visual user interfaces for a user or operator. The display devices may include display controllers. In one embodiment, the display device 125 is a portable tablet device or computing device with a touchscreen that displays data (e.g., PWM data for PWM valves, planting application data, fluid or fluid application data, captured images, localized view map layer, high definition field maps of as-applied fluid or fluid application data, as-planted or as-harvested data or other agricultural variables or parameters, yield maps, alerts, etc.) and data generated by an agricultural data analysis software application and receives input from the user or operator for an exploded view of a region of a field, monitoring and controlling field operations. The operations may include configuration of the machine or implement, reporting of data, control of the machine or implement including sensors and controllers, and storage of the data generated. The display device 130 may be a display (e.g., display provided by an original equipment manufacturer (OEM)) that displays images and data for a localized view map layer, as-applied fluid or fluid application data, as-planted or as-harvested data, yield data, controlling a machine (e.g., planter, tractor, combine, sprayer, etc.), steering the machine, and monitoring the machine or an implement (e.g., planter, combine, sprayer, etc.) that is connected to the machine with sensors and controllers located on the machine or implement.

A cab control module 1270 may include an additional control module for enabling or disabling certain components or devices of the machine or implement. For example, if the user or operator is not able to control the machine or implement using one or more of the display devices, then the cab control module may include switches to shut down or turn off components or devices of the machine or implement.

The implement 1240 (e.g., planter, cultivator, plough, sprayer, spreader, irrigation, implement, etc.) includes an implement network 150 having multiple networks, a processing system 162 having processing logic 164, a network interface 160, and optional input/output ports 166 for communicating with other systems or devices including the machine 102. The implement network 150 having multiple networks (e.g., Ethernet network, Power over Ethernet (PoE) network, a controller area network (CAN) serial bus protocol network, an ISOBUS network, etc.) may include a pump 156 for pumping fluid from a primary and one or more auxiliary storage tank(s) 190 to row units of the implement, communication modules (e.g., 180, 181) for receiving communications from controllers and sensors and transmitting these communications to the machine network. In one example, the communication modules include first and second network devices with network ports. A first network device with a port (e.g., CAN port) of communication module (CM) 180 receives a communication with data from controllers and sensors, this communication is translated or converted from a first protocol into a second protocol for a second network device (e.g., network device with a switched power line coupled with a communications channel, Ethernet), and the second protocol with data is transmitted from a second network port (e.g., Ethernet port) of CM 180 to a second network port of a second network device 113b of the machine network 110. A first network device 113a having first network ports (e.g., 1-4 CAN ports) transmits and receives communications from first network ports of the implement. In one example, the implement network 150 includes valve and nozzle assemblies 50, lights 60, vision guidance system 71 having cameras and processors, and autosteer controller 900 for various embodiments of this present disclosure. The autosteer controller 900 may also be part of the machine network 110 instead of being located on the implement network 150 or in addition to being located on the implement network 150.

Sensors 152 (e.g., speed sensors, seed sensors for detecting passage of seed, downforce sensors, actuator valves, OEM sensors, flow sensors, etc.), controllers 154 (e.g., drive system for seed meter, GPS receiver, controller(s) for one or more pumps and valves for fluid applications as described herein), and the processing system 162 control and monitoring operations of the implement.

The OEM sensors may be moisture sensors or flow sensors for a combine, speed sensors for the machine, seed force sensors for a planter, fluid application sensors for a sprayer, or vacuum, lift, lower sensors for an implement. For example, the controllers may include processors in communication with a plurality of seed sensors. The processors are configured to process data (e.g., fluid application data, seed sensor data) and transmit processed data to the processing system 162 or 1200. The controllers and sensors may be used for monitoring motors and drives on a planter including a variable rate drive system for changing plant populations. The controllers and sensors may also provide swath control to shut off individual rows or sections of the planter. The sensors and controllers may sense changes in an electric motor that controls each row of a planter individually. These sensors and controllers may sense seed delivery speeds in a seed tube for each row of a planter.

The network interface 160 can be a GPS transceiver, a WLAN transceiver (e.g., WiFi), an infrared transceiver, a Bluetooth transceiver, Ethernet, or other interfaces from communications with other devices and systems including the machine 102. The network interface 160 may be integrated with the implement network 150 or separate from the implement network 150 as illustrated in FIG. 8.

The processing system 162 communicates bi-directionally with the implement network 150, network interface 160, and I/O ports 166 via communication links 141-143, respectively. The implement communicates with the machine via wired and possibly also wireless bi-directional communications 104. The implement network 150 may communicate directly with the machine network 110 or via the network interfaces 115 and 160. The implement may also by physically coupled to the machine for agricultural operations (e.g., planting, harvesting, spraying, etc.). The memory 105 may be a machine-accessible non-transitory medium on which is stored one or more sets of instructions (e.g., software 106) embodying any one or more of the methodologies or functions described herein. The software 106 may also reside, completely or at least partially, within the memory 105 and/or within the processing system 1200 during execution thereof by the system 100, the memory and the processing system also constituting machine-accessible storage media. The software 106 may further be transmitted or received over a network via the network interface 115.

### EXAMPLES

The following are nonlimiting examples.

Example 1—a method of calibrating dosing valves of a sprayer system of an agricultural implement comprises initiating calibration tube fill mode of the sprayer system to initiate calibration by filling a calibration tube with fluid having a fluid from an auxiliary tank of the sprayer system; measuring, during a measure calibration tube volume mode, a volume of the fluid filled into the calibration tube; pumping, during a pump from calibration tube mode, the fluid in the calibration tube to the dosing valves to calibrate the dosing valves with respect to flow characteristics of the fluid with the dosing valves being capable of a high fluid flow rate to a low fluid flow rate ratio of at least 100:1 for the fluid; and pumping, during a pump from concentration tank mode, the fluid in the concentration tank to the dosing valves and then to a mixing apparatus with the fluid to be mixed with a carrier fluid from a primary tank of the sprayer system.

Example 2—the method of Example 1, wherein the dosing valves are calibrated with respect to flow characteristics of the fluid between a high fluid flow rate to a low fluid flow rate ratio of at least 1,000:1.

Example 3—the method of Example 1, wherein the dosing valves are calibrated with respect to flow characteristics of the fluid between a high fluid flow rate to a low fluid flow rate ratio of at least 10,000:1.

Example 4—the method of Example 1, wherein the high fluid flow rate is approximately 4 gallons per minute (GPM) and the low fluid flow rate is approximately 0.0004 GPM.

Example 5—the method of any of Examples 1-4, wherein the dosing valves are pulse width modulation (PWM) dosing valves.

Example 6—the method of any of Examples 1-5, further comprises pumping, during a pump from concentration tank with recirculation mode, the fluid in the concentration tank to the dosing valves with a valve to the calibration tube being open to allow a recirculation flow path from the concentration tank to the pump to the calibration tube and then returning to the concentration tank.

Example 7—the method of any of Examples 1-6, further comprises rinsing, during a sprayer system rinse mode, the fluid having the fluid out of fluid lines of the sprayer system.

Example 8—the method of any of Examples 1-7, further comprises applying, with a spray boom, the mixed fluid to an agricultural field.

Example 9—the method of any of Examples 1-8, wherein the dosing valves are integrated with a dosing valve set manifold.

Example 10—a sprayer system comprises at least one auxiliary tank; at least one calibration tube; at least one dosing valve set manifold; a controller in communication with the at least one dosing valve set manifold, the controller is configured during calibration tube fill mode, to perform operations to fill a calibrating tube with fluid having a fluid from an auxiliary tank of the at least one auxiliary tank, and during a pump from calibration tube mode, to pump the fluid in the calibration tube to the dosing valve set manifold to calibrate dosing valves of the dosing valve set manifold with respect to flow characteristics of the fluid with the dosing valve set manifold being capable of a high fluid flow rate to a low fluid flow rate ratio of at least 100:1 for the fluid.

Example 11—the sprayer system of Example 10, further comprises a primary tank; a primary spray boom; and a mixing apparatus to mix fluid from the at least one auxiliary tank and carrier fluid from the primary tank.

Example 12—the sprayer system of any of Examples 10-11, wherein the controller is configured to perform an operation during a pump from concentration tank mode, to pump the fluid in the at least one auxiliary tank to the dosing valve set manifold and then to the mixing apparatus with the fluid to be mixed with the carrier fluid from the primary tank of the spray system.

Example 13—the sprayer system of any of Examples 10-12, wherein the dosing valves are calibrated with respect to flow characteristics of the fluid between a high fluid flow rate to a low fluid flow rate ratio of at least 1,000:1.

Example 14—the sprayer system of any of Examples 10-13, wherein the dosing valves are calibrated with respect to flow characteristics of the fluid between a high fluid flow rate to a low fluid flow rate ratio of at least 10,000:1.

Example 15—the sprayer system of any of Examples 10-14, wherein the high fluid flow rate is approximately 4 gallons per minute (GPM) and the low fluid flow rate is approximately 0.0004 GPM.

Example 16—the sprayer system of any of Examples 10-15, wherein the dosing valves are pulse width modulation (PWM) dosing valves.

Example 17—the sprayer system of any of Examples 10-16, further comprises a pump in fluid communication with the mixing apparatus, the pump is activated in operation to pump if a flow rate of the fluid flowing through the mixing apparatus is below a threshold flow rate in order to prevent laminar flow through the mixing apparatus.

Example 18—the sprayer system of any of Examples 10-17, further comprises a secondary boom having a plurality of nozzles to apply a mixed fluid receiving from the mixing apparatus selectively to selective regions in an agricultural field.

Example 19—the sprayer system of any of Examples 10-18, wherein the at least one auxiliary tank comprises a first auxiliary tank and a second auxiliary tank, wherein the at least one calibration tube comprises a first calibration tube and a second calibration tube, wherein the at least one dosing valve set manifold comprises a first dosing valve set manifold and a second dosing valve set manifold.

Example 20—the sprayer system of any of Examples 10-19, wherein each dosing valve set manifold includes a first dosing valve having a first flow rate range and a second dosing valve having a second flow rate range.

Example 21—the sprayer system of any of Examples 10-19, wherein each dosing valve set manifold includes a first dosing valve having a first flow rate range (e.g., 0.0003 to 0.0270 GPM), a second dosing valve having a second flow rate range (e.g., 0.0238 to 0.4760 GPM), a third dosing valve having a third flow rate range (e.g., 0.0370 to 1.75 GPM), and a fourth dosing valve having a fourth flow rate range (e.g., 0.0370 to 1.75 GPM).

Example 22—the sprayer system of any one of Examples 10 to 20 further comprising a pump and a constant flow valve.

Example 23—the sprayer system of any one of Examples 10 to 21 further comprising a back pressure valve disposed before a return to the at least one auxiliary tank.

Example 24—a sprayer system comprising: at least one tank; at least one dosing valve set manifold in fluid communication with the at least one tank and comprising at least three dosing valves in parallel including a first dosing valve, a second dosing valve, and a third dosing valve; and wherein the second dosing valve has a minimum valve open time that is less than a maximum valve open time for the first dosing valve such that a flow rate of the second dosing valve overlaps a flow rate for the first dosing valve, and wherein the third dosing valve has a minimum valve open time that is less than a maximum valve open time for the second dosing valve such that a flow rate of the third dosing valve overlaps the flow rate for the second dosing valve.

Example 25—the sprayer system of Example 24 further comprising a first orifice disposed downstream of the first dosing valve, and a second orifice disposed downstream of the second orifice.

Example 26—the sprayer system of Example 24 or 25 further comprising a fourth dosing valve and a fifth dosing valve in the dosing valve set manifold, wherein when the third dosing valve is at its maximum output, flow through the dosing valve manifold is divided between the third dosing valve, the fourth dosing valve, and the fifth dosing valve.

The foregoing description is presented to enable one of ordinary skill in the art to make and use the invention and is provided in the context of a patent application and its requirements. Various modifications to the preferred embodiment of the apparatus, and the general principles and features of the system and methods described herein will be readily apparent to those of skill in the art. Thus, the present invention is not to be limited to the embodiments of the apparatus, system and methods described above and illustrated in the drawing figures, but is to be accorded the widest scope consistent with the spirit and scope of the appended claims.

1. A method of calibrating dosing valves of a sprayer system of an agricultural implement comprising:
initiating calibration tube fill mode of the sprayer system to initiate calibration by filling a calibration tube with fluid having a fluid from an auxiliary tank of the sprayer system;
measuring, during a measure calibration tube volume mode, a volume of the fluid filled into the calibration tube;
pumping, during a pump from calibration tube mode, the fluid in the calibration tube to the dosing valves to calibrate the dosing valves with respect to flow characteristics of the fluid with the dosing valves having a high fluid flow rate to a low fluid flow rate ratio of at least 100:1 for the fluid; and
pumping, during a pump from concentration tank mode, the fluid in the concentration tank to the dosing valves and then to a mixing apparatus with the fluid to be mixed with a carrier fluid from a primary tank of the sprayer system.

2. The method of claim 1, wherein the dosing valves are calibrated with respect to flow characteristics of the fluid between a high fluid flow rate to a low fluid flow rate ratio of at least 1,000:1.

3. The method of claim 1, wherein the dosing valves are calibrated with respect to flow characteristics of the fluid between a high fluid flow rate to a low fluid flow rate ratio of at least 10,000:1.

4. The method of claim 1, wherein the high fluid flow rate is approximately 4 gallons per minute (GPM) and the low fluid flow rate is approximately 0.0004 GPM.

5. The method of claim 1, wherein the dosing valves are pulse width modulation (PWM) dosing valves.

6. The method of claim 1, further comprising:
pumping, during a pump from concentration tank with recirculation mode, the fluid in the concentration tank to the dosing valves with a valve to the calibration tube being open to allow a recirculation flow path from the concentration tank to the pump to the calibration tube and then returning to the concentration tank.

7. The method of claim 1, further comprising:
rinsing, during a sprayer system rinse mode, the fluid having the fluid out of fluid lines of the sprayer system.

8. The method of claim 1, further comprising:
applying, with a spray boom, the mixed fluid to an agricultural field.

9. The method of any preceding claim, wherein the dosing valves are integrated with a dosing valve set manifold.

10. A sprayer system comprising:
at least one auxiliary tank;
at least one calibration tube;
at least one dosing valve set manifold; and
a controller in communication with the at least one dosing valve set manifold, the controller is configured for a calibration tube fill mode, to perform operations to fill a calibrating tube with fluid having a fluid from an auxiliary tank of the at least one auxiliary tank, and
during a pump from calibration tube mode, to pump the fluid in the calibration tube to the dosing valve set manifold to calibrate dosing valves of the dosing valve set manifold with respect to flow characteristics of the fluid with the dosing valve set manifold being capable of a high fluid flow rate to a low fluid flow rate ratio of at least 100:1 for the fluid.

11. The sprayer system of claim 10, further comprising:
a primary tank;
a primary spray boom having nozzles to apply a fluid from the primary tank to an agricultural field; and
a mixing apparatus to mix fluid from the at least one auxiliary tank and fluid from the primary tank of an agricultural implement.

12. The sprayer system of claim 11, wherein the controller is configured to perform an operation during a pump from concentration tank mode, to pump the fluid in the at least one auxiliary tank to the dosing valve set manifold and then to the mixing apparatus with the fluid to be mixed with the carrier fluid from the primary tank of the sprayer system.

13. The sprayer system of claim 10, wherein the dosing valves are calibrated with respect to flow characteristics of the fluid between a high fluid flow rate to a low fluid flow rate ratio of at least 1,000:1.

14. The sprayer system of claim 10, wherein the dosing valves are calibrated with respect to flow characteristics of the fluid between a high fluid flow rate to a low fluid flow rate ratio of at least 10,000:1.

15. The sprayer system of claim 10, wherein the high fluid flow rate is approximately 4 gallons per minute (GPM) and the low fluid flow rate is approximately 0.0004 GPM.

16. The sprayer system of claim 10, wherein the dosing valves are pulse width modulation (PWM) dosing valves.

17. The sprayer system of claim 11, further comprising:
a pump in fluid communication with the mixing apparatus, the pump is activated in operation to pump if a flow rate of the fluid flowing through the mixing apparatus is below a threshold flow rate in order to prevent laminar flow through the mixing apparatus.

18. The sprayer system of claim 11, further comprising:
a secondary boom having a plurality of nozzles to apply a mixed fluid received from the mixing apparatus selectively to selective regions in an agricultural field.

19. The sprayer system of claim 10, wherein the at least one auxiliary tank comprises a first auxiliary tank and a second auxiliary tank, wherein the at least one calibration tube comprises a first calibration tube and a second calibration tube, wherein the at least one dosing valve set manifold comprises a first dosing valve set manifold and a second dosing valve set manifold.

20. The sprayer system of claim 10, wherein each dosing valve set manifold includes a first dosing valve having a first flow rate range and a second dosing valve having a second flow rate range.

21. The sprayer system of claim 10, wherein each dosing valve set manifold includes a first dosing valve having a first flow rate range, a second dosing valve having a second flow rate range, a third dosing valve having a third flow rate range, and a fourth dosing valve having a fourth flow rate range.

22. The sprayer system of claim 10, further comprising a pump and a constant flow valve.

23. The sprayer system of claim 10, further comprising a back pressure valve disposed before a return to the at least one auxiliary tank.

24. A sprayer system comprising:
at least one tank;
at least one dosing valve set manifold in fluid communication with the at least one tank and comprising at least three dosing valves in parallel including a first dosing valve, a second dosing valve, and a third dosing valve; and
wherein the second dosing valve has a minimum valve open time that is less than a maximum valve open time for the first dosing valve such that a flow rate of the second dosing valve overlaps a flow rate for the first dosing valve, and
wherein the third dosing valve has a minimum valve open time that is less than a maximum valve open time for the second dosing valve such that a flow rate of the third dosing valve overlaps the flow rate for the second dosing valve.

25. The sprayer system of claim 24 further comprising a first orifice disposed downstream of the first dosing valve, and a second orifice disposed downstream of the second orifice.

26. The sprayer system of claim 24, further comprising a fourth dosing valve and a fifth dosing valve in the dosing valve set manifold, wherein when the third dosing valve is at its maximum output, flow through the dosing valve manifold is divided between the third dosing valve, the fourth dosing valve, and the fifth dosing valve.
